(19) United States
(12) Patent Application Publication
(10) Pub. No.: US 2013/0182795 A1
(43) Pub. Date: Jul. 18, 2013

(54) SYSTEMS AND METHODS FOR PEER-TO-PEER COMMUNICATION

(71) Applicant: QUALCOMM Incorporated, San Diego, CA (US)

(72) Inventors: George Cherian, San Diego, CA (US); Santosh Paul Abraham, San Diego, CA (US); Michaela Vanderveen, Tracy, CA (US); Hemanth Sampath, San Diego, CA (US)

(73) Assignee: QUALCOMM Incorporated, San Diego, CA (US)

(21) Appl. No.: 13/739,377

(22) Filed: Jan. 11, 2013

Related U.S. Application Data
(60) Provisional application No. 61/586,484, filed on Jan. 13, 2012.

(51) Int. Cl. H04L 25/02

(52) U.S. Cl. CPC H04L 25/02
USPC 375/316

(57) ABSTRACT

Methods, devices, and computer program products for peer-to-peer communication are described herein. In one aspect, an apparatus includes a receiver and processor. The receiver is configured to receive a first data unit from a first device. The first data unit includes a Media Access Control (MAC) address of the first device and data. The processor is configured to generate a device address of the processor and a device address of the first device, and provide the generated device address of the processor, the generated device address of the first device, and the data of the first data unit to an application executable on the processor.

### CROSS REFERENCE TO RELATED APPLICATIONS

This application claims benefit under 35 U.S.C. §119(e) to U.S. Provisional Patent Application No. 61/586,484 entitled “SYSTEMS AND METHODS FOR PEER-TO-PEER COMMUNICATION” filed on Jan. 13, 2012; the disclosure of which is hereby incorporated by reference in its entirety.

### FIELD

The present application relates generally to wireless communications, and more specifically to systems, methods, and devices for peer-to-peer communication.

### BACKGROUND

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network may transmit/receive information between one another. The information may comprise packets, which in some aspects may be referred to as data units. The packets may include overhead information (e.g., header information, packet properties, etc.) that helps in routing the packet through the network, identifying the data in the packet, processing the packet, etc., as well as data, for example user data, multimedia content, etc. as might be carried in a payload of the packet. Since the devices consume power during the process of transmitting and receiving packets, improved systems, methods, and devices for efficient peer-to-peer communication are desired.

### SUMMARY

The systems, methods, devices, and computer program products discussed herein each have several aspects, no single one of which is solely responsible for its desirable attributes. Without limiting the scope of this invention as expressed by the claims which follow, some features are discussed briefly below. After considering this discussion, and particularly after reading the section entitled “Detailed Description,” it will be understood how advantageous features of this invention include reduced power consumption when peer devices communicate in a wireless communication system.

One aspect of this disclosure provides an apparatus operable in a wireless communication network. The apparatus includes a receiver and processor. The receiver is configured to receive a first data unit from a first device. The first data unit includes a Media Access Control (MAC) address of the first device and data. The processor is configured to generate a device address of the processor and a device address of the first device, and provide the generated device address of the processor, the generated device address of the first device, and the data of the first data unit to an application executable on the processor.

Another aspect of this disclosure provides a method of wireless communication in a wireless communication network performed by an apparatus that includes a processor. The method includes: receiving a first data unit from a first device, the first data unit comprising a Media Access Control (MAC) address of the first device and data; generating a device address of the processor and a device address of the first device; and providing the generated device address of the processor, the generated device address of the first device, and the data of the first data unit to an application executable on the processor.

One aspect of this disclosure provides an apparatus operable in a wireless communication network. The apparatus includes: means for receiving a first data unit from a first device, the first data unit comprising a Media Access Control (MAC) address of the first device and data; means for generating a device address of the means for generating and a device address of the first device; and means for providing the generated device address of the means for generating, the generated device address of the first device, and the data of the first data unit to an application executable on the means for generating.

Another aspect of this disclosure provides a non-transitory computer storage that stores executable program instructions that direct an apparatus including a processor to perform a process. The process includes: receiving a first data unit from a first device, the first data unit comprising a Media Access Control (MAC) address of the first device and data; generating a device address of the processor and a device address of the first device; and providing the generated device address of the processor, the generated device address of the first device, and the data of the first data unit to an application executable on the processor.

One aspect of this disclosure provides an apparatus operable in a wireless communication network. The apparatus includes a processor and transmitter. The processor is configured to generate a network address of the processor and a service name of the processor. The transmitter is configured to transmit an advertisement message including the generated network address of the processor and the generated service name of the processor. The advertisement message may be a single message, and the transmitter may be configured to transmit the advertisement message one or more times. The processor may be configured to generate the network address of the processor based on a Media Access Control address of the processor. The processor may be configured to select a first algorithm of a plurality of algorithms to generate the network address of the processor. The advertisement message may comprise a frame including a payload, the payload comprising a neighbor solicitation message and a multicast domain name system message. The frame may comprise a management frame and not a data frame. The advertisement message may comprise a multicast domain name system message including a payload, the payload comprising a neighbor solicitation message. The advertisement message may comprise an indication that the advertisement message includes a multicast domain name system (mDNS) message, the indication configured to trigger devices to cache data of the advertisement message. The advertisement message may comprise a protocol identifier field configured to indicate a protocol used for discovery and a domain name field configured to indicate the generated service name of the processor. The advertisement message may comprise at least one of an action frame and an information element, the at least one of the action frame and the information element may comprise a protocol identifier field configured to indicate a protocol used for discovery, a service type field configured to indicate a type of service provided by the processor, a network address field configured to indicate the generated network address of the processor, and a domain name field configured to indicate the generated service name of the processor. The advertisement message may comprise at least one of a Universal Plug and Play message and a Bonjour message, and the processor may be further configured to compress the advertisement message to remove data of at least one data field before the transmitter transmits the advertisement message.

Another aspect of this disclosure provides an apparatus operable in a wireless communication network. The apparatus includes a receiver and processor. The receiver is configured to receive an advertisement message from a first device. The advertisement message includes a network address of the first device and a service name of the first device. The network address of the first device and the service name of the first device are generated by the first device. The processor is configured to store the network address of the first device and the service name of the first device. The advertisement message may be a single message, and the receiver may be configured to receive the advertisement message one or more times. The advertisement message may comprise a frame including a payload, the payload comprising a neighbor solicitation message and a multicast domain name system message. The frame may comprise a management frame and not a data frame. The advertisement message may comprise a multicast domain name system message including a payload, the payload comprising a neighbor solicitation message. The advertisement message may comprise an indication that the advertisement message includes a multicast domain name system message, the indication configured to trigger devices to cache data of the advertisement message. The advertisement message may comprise a protocol identifier field configured to indicate a protocol used for discovery and a domain name field configured to indicate the generated service name of the first device. The advertisement message may comprise at least one of an action frame and an information element, the at least one of the action frame and the information element may comprise a protocol identifier field configured to indicate a protocol used for discovery, a service type field configured to indicate a type of service provided by the first device, a network address field configured to indicate the generated network address of the first device, and a domain name field configured to indicate the generated service name of the first device. The advertisement message may comprise at least one of a Universal Plug and Play message and a Bonjour message, and the processor may be further configured to decompress the advertisement message.

One aspect of this disclosure provides an apparatus operable in a wireless communication network. The apparatus includes a processor and transmitter. The processor is configured to generate a network address of the processor. The transmitter is configured to transmit a message. The message includes the generated network address of the processor and a service discovery message. The service discovery message may comprise a domain name system (DNS) service discovery message.

Another aspect of this disclosure provides an operable in a wireless communication network. The apparatus includes a receiver and a processor. The receiver is configured to receive a message from a first device. The message includes a network address of the first device and a service discovery message. The network address of the first device is generated by the first device. The processor is configured to store the network address of the first device generated by the first device and data of the service discovery message. The service discovery message may comprise a domain name system (DNS) service discovery message.

One aspect of this disclosure provides a method of wireless communication in a wireless communication network performed by an apparatus including a processor, the method comprising: generating a network address of the processor and a service name of the processor; and transmitting an advertisement message comprising the generated network address of the processor and the generated service name of the processor. The method may further comprise transmitting the advertisement message one or more times, the advertisement message being a single message. Said generating the network address of the processor may comprise generating the network address of the processor based on a Media Access Control address of the processor. The method may further comprise selecting a first algorithm of a plurality of algorithms for generating the network address of the processor. The advertisement message may comprise a frame including a payload, the payload comprising a neighbor solicitation message and a multicast domain name system message. The frame may comprise a management frame and not a data frame. The advertisement message may comprise a multicast domain name system message including a payload, the payload comprising a neighbor solicitation message. The advertisement message may comprise an indication that the advertisement message includes a multicast domain name system (mDNS) message, the indication configured to trigger devices to cache data of the advertisement message. The advertisement message may comprise a protocol identifier field configured to indicate a protocol used for discovery and a domain name field configured to indicate the generated service name of the processor. The advertisement message may comprise at least one of an action frame and an information element, the at least one of the action frame and the information element may comprise a protocol identifier field configured to indicate a protocol used for discovery, a service type field configured to indicate a type of service provided by the processor, a network address field configured to indicate the generated network address of the processor, and a domain name field configured to indicate the generated service name of the processor. The method may further comprise compressing the advertisement message to remove data of at least one data field before transmitting the advertisement message, wherein the advertisement message may comprise at least one of a Universal Plug and Play message and a Bonjour message.

Another aspect of this disclosure provides a method of wireless communication in a wireless communication network performed by an apparatus including a processor, the method comprising: receiving an advertisement message from a first device, the advertisement message comprising a network address of the first device and a service name of the first device, the network address of the first device and the service name of the first device generated by the first device; and storing the network address of the first device and the service name of the first device. The method may further comprise receiving the advertisement message one or more times, the advertisement message being a single message. The advertisement message may comprise a frame including a payload, the payload comprising a neighbor solicitation message and a multicast domain name system message. The frame may comprise a management frame and not a data frame. The advertisement message may comprise a multicast domain name system message including a payload, the payload comprising a neighbor solicitation message. The advertisement message may comprise an indication that the advertisement message includes a multicast domain name system message, the indication configured to trigger devices to cache data of the advertisement message. The advertisement message may comprise a protocol identifier field configured to indicate a protocol used for discovery and a domain name field configured to indicate the generated service name of the first device. The advertisement message may comprise at least one of an action frame and an information element, the at least one of the action frame and the information element may comprise a protocol identifier field configured to indicate a protocol used for discovery, a service type field configured to indicate a type of service provided by the first device, a network address field configured to indicate the generated network address of the first device, and a domain name field configured to indicate the generated service name of the first device. The method may further comprise decompressing the advertisement message, wherein the advertisement message may comprise at least one of a Universal Plug and Play message and a Bonjour message.

One aspect of this disclosure provides a method of wireless communication in a wireless communication network performed by an apparatus including a processor, the method comprising: generating a network address of the processor; and transmitting a message, the message comprising the generated network address of the processor and a service discovery message. The service discovery message may comprise a domain name system (DNS) service discovery message.

Another aspect of this disclosure provides a method of wireless communication in a wireless communication network performed by an apparatus including a processor, the method comprising: receiving a message from a first device, the message comprising a network address of the first device and a service discovery message, the network address of the first device generated by the first device; and storing the network address of the first device generated by the first device and data of the service discovery message. The service discovery message may comprise a domain name system (DNS) service discovery message.

One aspect of this disclosure provides an apparatus operable in a wireless communication network, the apparatus comprising: means for generating a network address of the means for generating and a service name of the means for generating; and means for transmitting an advertisement message comprising the generated network address of the means for generating and the generated service name of the means for generating.

Another aspect of this disclosure provides an apparatus operable in a wireless communication network, the apparatus comprising: means for receiving an advertising message from a first device, the advertisement message comprising a network address of the first device and a service name of the first device, the network address of the first device and the service name of the first device generated by the first device; and means for storing the network address of the first device and the service name of the first device.

One aspect of this disclosure provides an apparatus operable in a wireless communication network, the apparatus comprising: means for generating a network address of the means for generating; and means for transmitting a message, the message comprising the generated network address of the means for generating and a service discovery message.

Another aspect of this disclosure provides an apparatus operable in a wireless communication network, the apparatus comprising: means for receiving a message from a first device, the message comprising a network address of the first device and a service discovery message, the network address of the first device generated by the first device; and means for storing the network address of the first device generated by the first device and data of the service discovery message.

One aspect of this disclosure provides a non-transitory computer storage that stores executable program instructions that direct an apparatus including a processor to perform a process that comprises: generating a network address of the processor and a service name of the processor; and transmitting an advertisement message comprising the generated network address of the processor and the generated service name of the processor.

Another aspect of this disclosure provides a non-transitory computer storage that stores executable program instructions that direct an apparatus including a processor to perform a process that comprises: receiving an advertisement message from a first device, the advertisement message comprising a network address of the first device and a service name of the first device, the network address of the first device and the service name of the first device generated by the first device; and storing the network address of the first device and the service name of the first device.

One aspect of this disclosure provides a non-transitory computer storage that stores executable program instructions that direct an apparatus including a processor to perform a process that comprises: generating a network address of the processor; and transmitting a message, the message comprising the generated network address of the processor and a service discovery message.

Another aspect of this disclosure provides a non-transitory computer storage that stores executable program instructions that direct an apparatus including a processor to perform a process that comprises: receiving a message from a first device, the message comprising a network address of the first device and a service discovery message, the network address of the first device generated by the first device; and storing the network address of the first device generated by the first device and data of the service discovery message.

One aspect of this disclosure provides an apparatus operable in a wireless communication network. The apparatus includes a receiver, processor, and transmitter. The receiver is configured to receive a service discovery message from a first device. The service discovery message requests a service in the wireless communication network. The processor is configured to determine whether a second device has transmitted a response message in response to the service discovery message. The response message indicates a request by the first device for the service and at least one device that provides the service. The transmitter is configured to transmit the response message in response to determining that the second device has not transmitted the response message. The receiver may be further configured to receive a configuration message from a third device, the configuration message indicating a service name of the third device or a service provided by the third device in the wireless communication network. The processor may be further configured to: determine whether the third device provides the service requested in the service discovery message, and in response to determining that the third device provides the service requested in the service discovery message, indicate in the response message transmitted by the transmitter that the third device provides the service. The processor may be further configured to: determine whether the third device provides the service requested in the service discovery message, in response to determining that the third device provides the service requested in the service discovery message, compare a ranking of the third device to a threshold, and based on the comparison of the ranking of the third device to the threshold, determine whether to indicate in the response message transmitted by the transmitter that the third device provides the service. The processor may be configured to determine whether the second device has transmitted the response message when the processor is connected to mains power. The processor may be configured to determine whether the second device has transmitted the response message when the processor volunteers to determine whether the second device has transmitted the response message. The processor may be configured to determine whether the second device has transmitted the response message when the processor is designated by another device to determine whether the second device has transmitted the response message. The processor may be configured to determine whether the second device has transmitted the response message when a Media Access Control (MAC) address of the processor satisfies a first condition.

Another aspect of this disclosure provides a method of wireless communication in a wireless communication network performed by an apparatus including a processor, the method comprising: receiving a service discovery message from a first device, the service discovery message requesting a service in the wireless communication network; determining whether a second device has transmitted a response message in response to the service discovery message, the response message indicating a request by the first device for the service and at least one device that provides the service; and transmitting the response message in response to determining that the second device has not transmitted the response message. The method may comprise receiving a configuration message from a third device, the configuration message indicating a service name of the third device or a service provided by the third device in the wireless communication network. The method may further comprise: determining whether the third device provides the service requested in the service discovery message; and in response to determining that the third device provides the service requested in the service discovery message, indicating in the response message that the third device provides the service. The method may further comprise: determining whether the third device provides the service requested in the service discovery message; in response to determining that the third device provides the service requested in the service discovery message, comparing a ranking of the third device to a threshold; and based on the comparison of the ranking of the third device to the threshold, determining whether to indicate in the response message transmitted by the transmitter that the third device provides the service. The method may further comprise determining whether the second device has transmitted the response message when the processor is connected to mains power. The method may further comprise determining whether the second device has transmitted the response message when the apparatus volunteers to determine whether the second device has transmitted the response message. The method may further comprise determining whether the second device has transmitted the response message when the apparatus is designated by another device to determine whether the second device has transmitted the response message. The method may further comprise determining whether the second device has transmitted the response message when a Media Access Control (MAC) address of the processor satisfies a first condition.

One aspect of this disclosure provides an apparatus operable in a wireless communication network, the apparatus comprising: means for receiving a service discovery message from a first device, the service discovery message requesting a service in the wireless communication network; means for determining whether a second device has transmitted a response message in response to the service discovery message, the response message indicating a request by the first device for the service and at least one device that provides the service; and means for transmitting the response message in response to determining that the second device has not transmitted the response message.

Another aspect of this disclosure provides a non-transitory computer storage that stores executable program instructions that direct an apparatus including a processor to perform a process that comprises: receiving a service discovery message from a first device, the service discovery message requesting a service in the wireless communication network; determining whether a second device has transmitted a response message in response to the service discovery message, the response message indicating a request by the first device for the service and at least one device that provides the service; and transmitting the response message in response to determining that the second device has not transmitted the response message.

### BRIEF DESCRIPTION OF THE DRAWINGS

FIG. 1 illustrates an example of a wireless communication system in which aspects of the present disclosure may be employed.

FIG. 2 shows a functional block diagram of a wireless device that may be employed within the wireless communication system of FIG. 1.

FIG. 3 illustrates an example wireless communication system.

FIG. 4 illustrates an example wireless communication system.

FIG. 5 illustrates an example action frame format.

FIG. 6 illustrates an example information element format.

FIG. 7 illustrates an example Bonjour message format.

FIG. 8 illustrates an example UPnP search message format.

FIG. 9 illustrates an example UPnP notify message format.

FIG. 10 illustrates an example UPnP notify message format.

FIG. 11 is a graph illustrating message transmission times for various approaches to carrying discovery information.

FIG. 12 is a flowchart of an example process of communicating in a wireless communication system in accordance with aspects of the present disclosure.

FIG. 13 is a functional block diagram of an example wireless device.

FIG. 14 is a flowchart of an example process of communicating in a wireless communication system in accordance with aspects of the present disclosure.

FIG. 15 is a functional block diagram of an example wireless device.

FIG. 16 is a flowchart of an example process of communicating in a wireless communication system in accordance with aspects of the present disclosure.

FIG. 17 is a functional block diagram of an example wireless device.

FIG. 18 is a flowchart of an example process of communicating in a wireless communication system in accordance with aspects of the present disclosure.

FIG. 19 is a functional block diagram of an example wireless device.

FIG. 20 is a flowchart of an example process of communicating in a wireless communication system in accordance with aspects of the present disclosure.

FIG. 21 is a functional block diagram of an example wireless device.

FIG. 22 is a flowchart of an example process of communicating in a wireless communication system in accordance with aspects of the present disclosure.

FIG. 23 is a functional block diagram of an example wireless device.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some aspects, wireless signals in a sub-gigahertz band may be transmitted according to the 802.11ah protocol using orthogonal frequency-division multiplexing (OFDM), direct—sequence spread spectrum (DSSS) communications, a combination of OFDM and DSSS communications, or other schemes. Implementations of the 802.11ah protocol may be used for sensors, metering, and smart grid networks. Advantageously, aspects of certain devices implementing the 802.11ah protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (“APs”) and clients (also referred to as stations, or “STAs”). In general, an AP may serve as a hub or base station for the WLAN and an STA serves as a user of the WLAN. For example, an STA may be a laptop computer, a personal digital assistant (PDA), a mobile phone, etc. In an example, an STA connects to an AP via a WiFi (e.g., IEEE 802.11 protocol such as 802.11ah) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station (“STA”) may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein may implement the 802.11ah standard, for example. Such devices, whether used as an STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

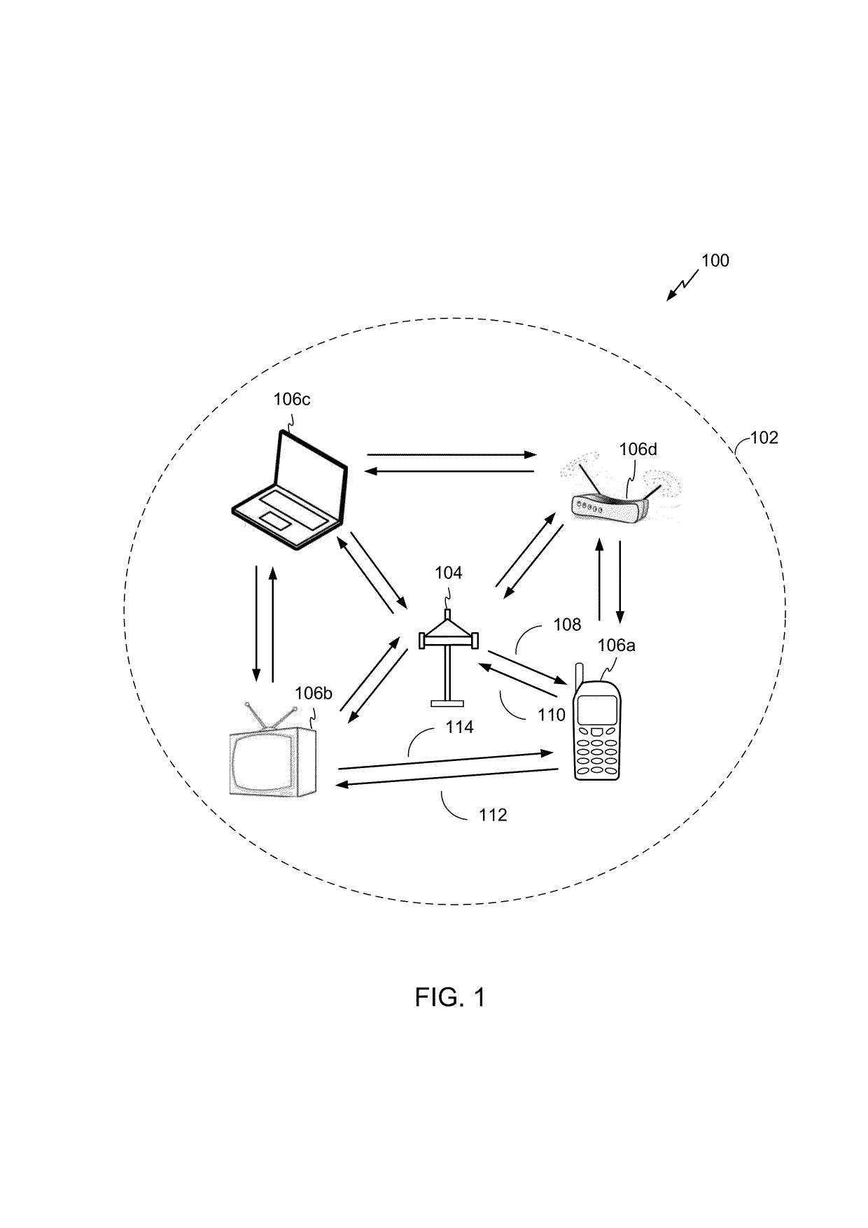

FIG. 1 illustrates an example of a wireless communication system 100 in which aspects of the present disclosure may be employed. The wireless communication system 100 may operate pursuant to a wireless standard, for example the 802.11ah standard. The wireless communication system 100 may include an AP 104, which communicates with STAs 106. In some aspects, the wireless communication system 100 may include more than one AP. Additionally, the STAs 106 may communicate with other STAs 106. As an example, a first STA 106a may communicate with a second STA 106b. As another example, a first STA 106a may communicate with a third STA 106c although this communication link is not illustrated in FIG. 1.

A variety of processes and methods may be used for transmissions in the wireless communication system 100 between the AP 104 and the STAs 106 and between an individual STA, such as the first STA 106a, and another individual STA, such as the second STA 106b. For example, signals may be sent and received in accordance with OFDM/OFDMA techniques. If this is the case, the wireless communication system 100 may be referred to as an OFDM/OFDMA system. Alternatively, signals may be sent and received between the AP 104 and the STAs 106 and between an individual STA, such as the first STA 106a, and another individual STA, such as the second STA 106b, in accordance with CDMA techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

A communication link may be established between STAs. Some possible communication links between STAs are illustrated in FIG. 1. As an example, a communication link 112 may facilitate transmission from the first STA 106a to the second STA 106b. Another communication link 114 may facilitate transmission from the second STA 106b to the first STA 106a.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106.

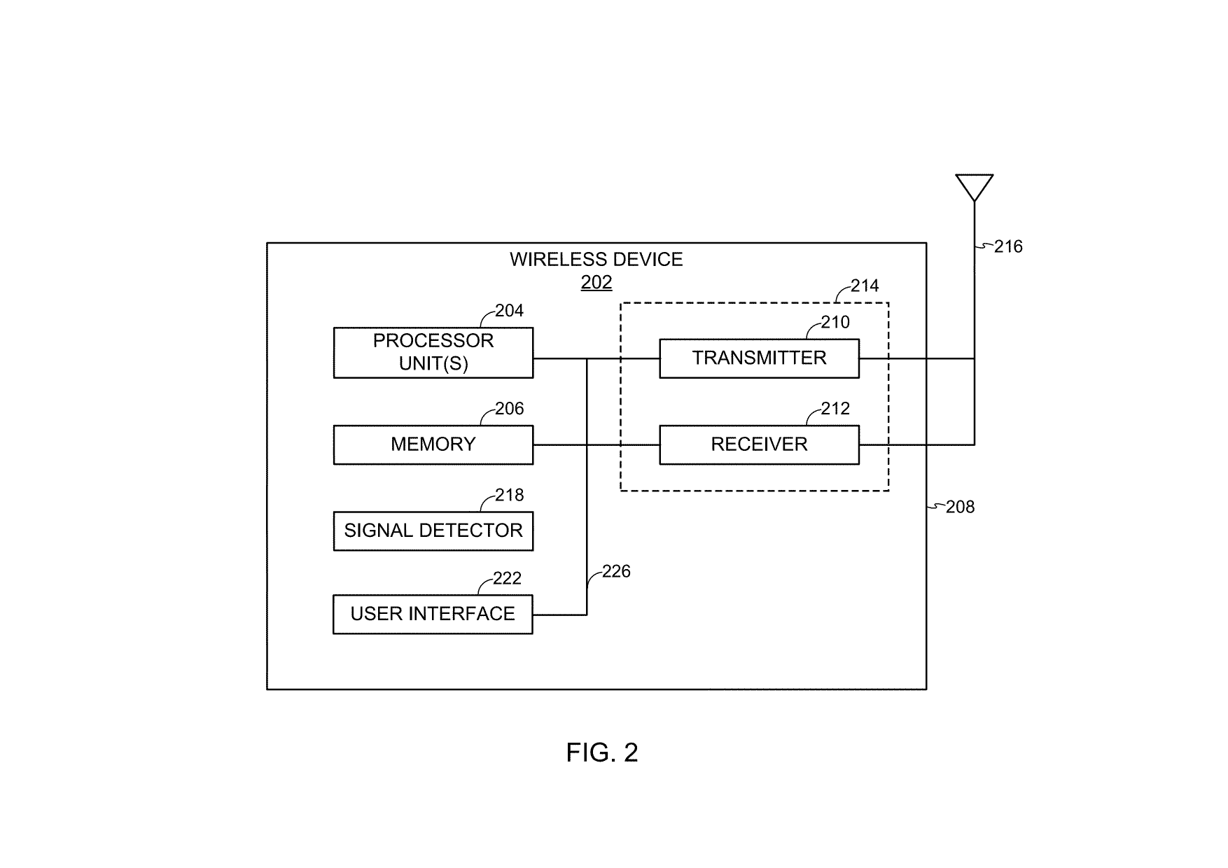

FIG. 2 illustrates various components that may be utilized in a wireless device 202 that may be employed within the wireless communication system 100. The wireless device 202 is an example of a device that may be configured to implement the various methods described herein. For example, the wireless device 202 may comprise the AP 104 or one of the STAs 106.

The wireless device 202 may include a processor 204 which controls operation of the wireless device 202. The processor 204 may also be referred to as a central processing unit (CPU). Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and/or a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The transmitter 210 may be configured to wirelessly transmit packets having different packet types or functions. For example, the transmitter 210 may be configured to transmit packets of different types generated by the processor 204. When the wireless device 202 is implemented or used as an AP 104 or STA 106, the processor 204 may be configured to process packets of a plurality of different packet types. For example, the processor 204 may be configured to determine the type of packet and to process the packet and/or fields of the packet accordingly. When the wireless device 202 is implemented or used as an AP 104, the processor 204 may also be configured to select and generate one of a plurality of packet types. For example, the processor 204 may be configured to generate a discovery packet comprising a discovery message and to determine what type of packet information to use in a particular instance.

The receiver 212 may be configured to wirelessly receive packets having different packet types. In some aspects, the receiver 212 may be configured to detect a type of a packet used and to process the packet accordingly.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a packet for transmission. In some aspects, the packet may comprise a physical layer data unit (PPDU).

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. The components of the wireless device 202 may be coupled together or accept or provide inputs to each other using some other mechanism.

Although a number of separate components are illustrated in FIG. 2, one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

To ensure proper communication between devices such as AP 104 and the STAs 106, the AP 104 or STAs 106 may use information regarding characteristics of the AP 104 or STAs 106. For example, the STA 106 may use timing information about the AP 104 in order to synchronize timing of communication between the STA 106 and the AP 104. Additionally or alternatively, the STA 106 may use other information such as a unique identifier assigned to the AP 104 for communications on a network (e.g., a Media Access Control (MAC) address), an identifier of the basic service set (BSS) served by the AP 104, etc. The STA 106 may determine whether it may use such information independently, such as through software running using memory 206 and processor 204.

The AP 104 or STA 106 may have a plurality of operational modes. For example, the STA 106 may have a first operational mode referred to as an active mode, normal operation mode, or full power mode. In the active mode, the AP 104 or STA 106 may always be in an “awake” state and actively transmit/receive data with another STA 106. Further, the STA 106 may have a second operational mode referred to as a power-save mode or sleep mode. In the power-save mode, the AP 104 or STA 106 may be in the “awake” state or a “doze” or “sleep” state where the AP 104 or STA 106 does not actively transmit/receive data with another STA 106. For example, the receiver 212 and possibly DSP 220 and signal detector 218 of the STA 106 may operate using reduced power consumption in the doze state. Further, in the power-save mode, an STA 106 may occasionally enter the awake state to listen to messages from an AP 104 (e.g., paging messages) that indicate to the STA 106 whether or not the STA 106 needs to “wake up” (e.g., enter the awake state) at a certain time so as to be able to transmit/receive data with the AP 104 or another STA.

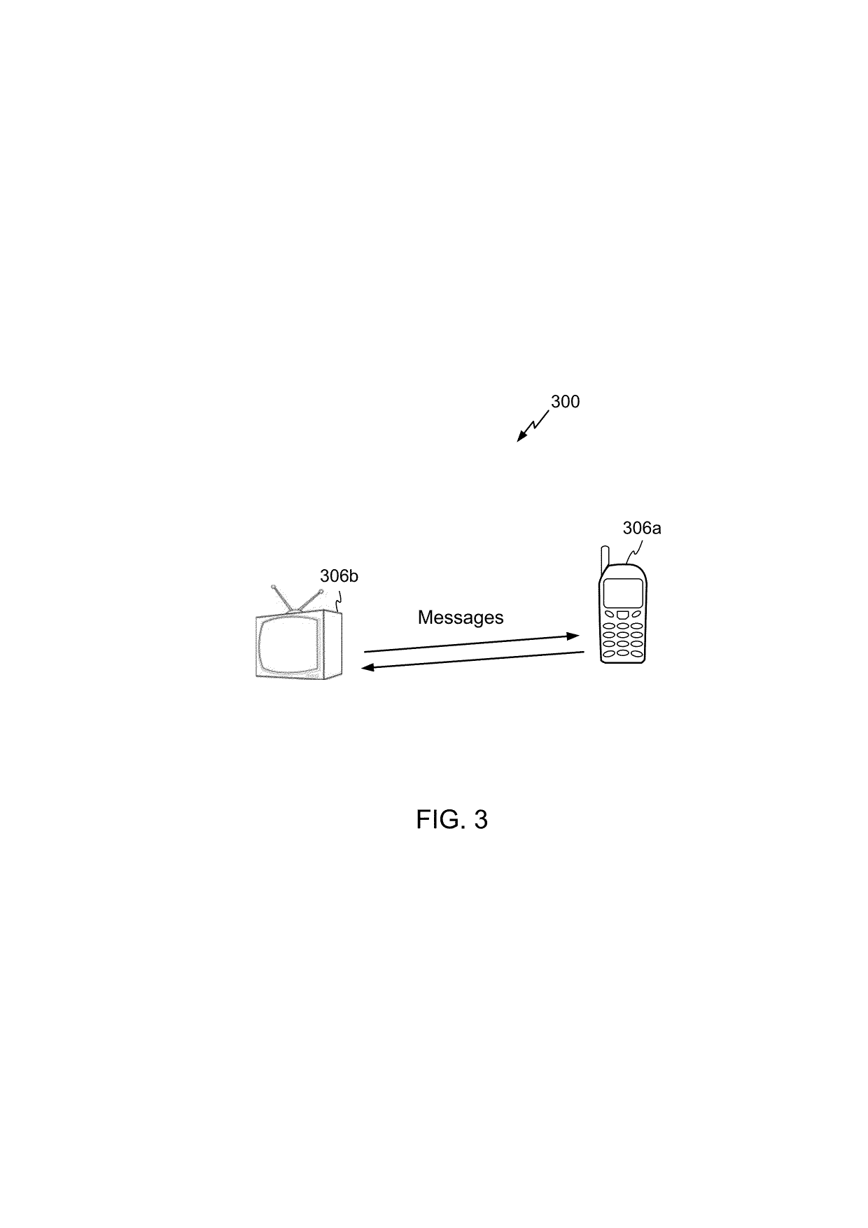

FIG. 3 illustrates an example wireless communication system or network 300. The wireless communication system 300 includes at least a first STA 306a and a second STA 306b. The first STA 306a may transmit messages, such as packets, to the second STA 306b. The second STA 306b may also transmit messages to the first STA 306a. Additionally, the wireless communication system 300 may include other STAs or APs (not shown) that communicate in ways described in this disclosure. However, to explain some aspects, the first STA 306a and the second STA 306b are provided as examples.

The first STA 306a may advertise one or more services (e.g., features of applications shared by the first STA 306a) that are provided by the first STA 306a in the wireless communication system 300. Before transmitting messages to advertise the one or more services provided by the first STA 306a, the first STA 306a may determine (e.g., generate or receive) a service name and/or device address (e.g., network address, logical address, Internet Protocol address) for itself for use in the wireless communication system 300. In some aspects, the first STA 306a may transmit a configuration message (e.g., advertisement message) including both a generated device address and a generated service name. The configuration message may be a single message that is transmitted one or more times by the first STA 306a. In some aspects, the configuration message may include a frame that contains a neighbor solicitation (NS) message and a multicast domain name system (mDNS) query message within the payload. Alternatively or alternatively, the configuration message may include an mDNS query message having a payload that includes a NS message. Advantageously, the configuration message may be used to inquire whether the device address and service name determined for use by the first STA 306a is in use by another device in the wireless communication system 300. One or more devices in the wireless communication system 300 may receive one or more transmissions of the configuration message and respond to the configuration message by notifying the first STA 306a if the device address is already in use. In some aspects, the configuration message may also include a discovery message configured to advertise one or more services that are provided by the first STA 306a.

In some aspects, the first STA 306a may generate its own device address or service name. The first STA 306a may utilize or choose among various schemes, including one or more of look-up tables, algorithms, random value generations, or functions based on particular values such as MAC addresses, and the like to generate its own device address or service name.

The second STA 306b may receive messages, such as configuration messages or discovery messages, from other devices, such as the first STA 306a. The second STA 306b may cache data contained in some or all received messages. The cached data may include information such as device addresses, MAC addresses, domain names, or service names, etc. In some aspects, certain configuration messages, like a message layer 2 encapsulation of an mDNS message, may contain an indicator (e.g., via ethertype) that triggers the automatic caching of such data from the received messages.

The data cached by the second STA 306b may be later accessed, for instance, to enable to the second STA 306b to contact the first STA 306a without first transmitting an address resolution protocol (ARP) request message. The second STA 306b may have stored the MAC address of the first STA 306a and thus may mark a message for transmission to the first STA 306a without requesting a physical address of the first STA 306a from another device. Such an approach may be advantageous to save time and power that otherwise may be used for sending, receiving, and processing an ARP request message and an ARP response message. Further, the second STA 306b and the first STA 306a may communicate directly without first seeking an address resolution from another device. As a result, the communication medium may remain free of some or all ARP request messages and ARP response messages, and devices may more efficiently or effectively utilize the communication medium.

The second STA 306b may further cache data about multiple services provided by devices in the wireless communication system 300. For example, the second STA 306b may maintain a table that maps services provided by service providing devices, such as the first STA 306a, to device addresses of the service providing devices. The data about the multiple services may include service names and/or domain names, and the like. In some implementations, a single service name may map to more than one device address. In addition, the second STA 306b may determine or store rankings of service providing devices for various services or particular service names.

When the second STA 306b may request a service, the second STA 306b may transmit a request message. The request message may indicate interest by the second STA 306b in one or more services and, for example, may include a DNS service discovery (DNS-SD) message. In some aspects, the request message may also include a device address of the second STA 306b generated by the second STA 306b and be used to determine whether the generated device address may be in use by another device in the wireless communication system 300. The first STA 306a, being a service providing device, may receive the request message and, if the first STA 306b provides a service requested by the second STA 306b, may transmit a response message to the second STA 306b. The response message may indicate that the first STA 306a provides at least one service requested by the second STA 306b. In some aspects, a time to live (TTL) field of the request message may advantageously be set to a certain value so that routers (not shown) in the wireless communication system 300 may know not forward the request message.

In addition, the second STA 306b may generate a device address (e.g., network address, logical address, Internet Protocol address) for the second STA 306b or for other devices and include the device address or addresses in request messages. The second STA 306b may utilize or choose among various schemes, including one or more of look-up tables, algorithms, random value generations, or functions based on particular values such as MAC addresses, and the like, to generate device addresses. The one or more schemes utilized or selected by the first STA 306a and the second STA 306may be the same in some aspects and different in other aspects.

Devices in the wireless communication system 300, such as the first STA 306a and the second STA 306b, may maintain a cache of generated device addresses for themselves and peer devices in the wireless communication system 300. Each generated device address may be associated with a corresponding MAC address, a corresponding domain name, or a corresponding service name of itself or a peer device, for instance. The stored MAC addresses of devices may be subsequently retrieved or determined based on the association between the corresponding generated device addresses and the corresponding MAC addresses of devices. In some aspects, the generated device addresses may be the same among some or all devices while, in other aspects, the generated device addresses may be different among some or all devices in the wireless communication system 300. The generated device addresses may in turn be provided to applications of the STAs that are designed to work with, for instance, an IP based network stack and permit those applications to function in a peer-to-peer context. Advantageously, in some aspects, device addresses such as IP addresses thus may not be relied upon to address communications between devices in the wireless communication system 300 and may instead be generated and managed locally for use in execution of applications of the first STA 306a and the second STA 306b. The MAC address of devices, in some implementations, may instead be used to address communications.

As an example, a transmitting device such as the first STA 306a may generate an IP address for itself and the second STA 306b. The first STA 306a may have generated the IP addresses after receiving a first message or data unit from the second STA 306b. The first message may have included one or more of the MAC address of the first STA 306a, the MAC address of the second STA 306b, an IP address of the first STA 306a generated by the second STA 306b, and an IP address of the second STA 306b generated by the second STA 306b. The first STA 306a may maintain mapping table that maps its generated IP address for itself and the second STA 306b to corresponding MAC addresses, corresponding service names, and corresponding domain names. Subsequently, the first STA 306a may transmit a second message to the second STA 306b without transmitting an ARP request because the first STA 306a may have already cached the MAC address of the second STA 306b. The second message transmitted to the second STA 306b may include one or more of the MAC address of the first STA 306a, the MAC address of the second STA 306b, the IP address of the first STA 306a generated by the first STA 306a, and the IP address of the second STA 306b generated by the first STA 306a. When the second STA 306b may receive the second message, the second STA 306b may replace the sender IP address and destination IP address of the second message with the IP addresses generated by the second STA 306b before then providing data of the second message to an application of the second STA 306b. Such a design may advantageously permit legacy devices or applications executed by devices to more easily participate in a peer-to-peer wireless communication protocol.

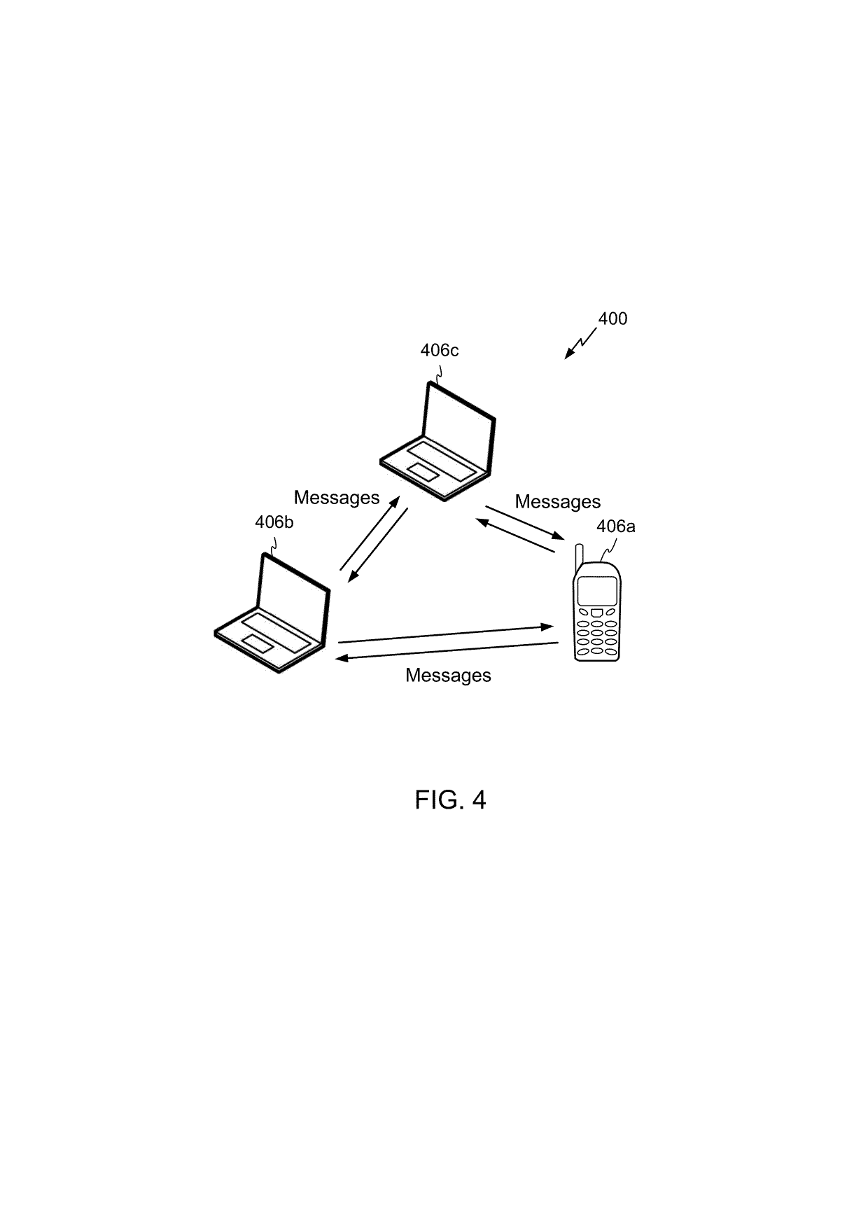

FIG. 4 illustrates an example wireless communication system or network 400. The wireless communication system 400 may include a first STA 406a, a second STA 406b, and a third STA 406c. The first STA 406a may transmit messages, such as packets, to the second STA 406b and the third STA 406c. The second STA 406b may transmit messages to the first STA 406a and the third STA 406c. The third STA 306c may transmit messages to the first STA 406a and the second STA 406b. Additionally, the wireless communication system 400 may include other STAs or APs (not shown) that communicate in ways described in this disclosure. However, to demonstrate some aspects, the first STA 406a, the second STA 406b, and the third STA 406c are provided as examples.

Service provider devices, such as the first STA 406a, may periodically transmit configuration messages or discovery messages like DNS-SD messages, announcing a device name and/or services provided by the devices. Other devices may receive the configuration messages and thereby know that a service provider device resides in the wireless communication system 400 and what services may be available. Some or all devices in the wireless communication system 400 may cache information transmitted or received in configuration messages. The information cached may include data indicative of services provided by service provider devices, in addition to corresponding device addresses (e.g., IP addresses) or layer 2 addresses (e.g., MAC addresses) of the service provider devices.

Service consumer devices, such as the second STA 406b, may transmit request messages requesting one or more services from another device in the wireless communication system 400. A service consumer device may transmit the request message, for example, because the service consumer device may not have received a configuration message advertising a desired service or a configuration message from a particular type or quality of service provider device. A service provider device may respond to the request message with a response message indicating that one or more service provider devices offer the requested service.

In some aspects, a request message may trigger one or more response messages, such as multicast response messages, from one or more devices functioning in a proxy capacity in the wireless communication system 400. Such an approach may be advantageous when, for instance, service provider devices may be in a power-save mode or sleep mode when a request message is transmitted and unable to receive the request message or respond. In addition, such an approach may limit the number or timing of the one or more devices that respond to prevent from overwhelming the wireless communication system 400 with response messages.

A response message may identify the sender of a request message corresponding to the response message. This identification may allow other devices functioning in a proxy capacity that are preparing or prepared to transmit a response message responding to the same request message to determine whether another device has transmitted a response message and, if so, to cancel or delay transmission since the requesting device may have already received the requested response information. In addition, devices functioning in a proxy capacity may be configured to transmit the response message in response to determining that another device has not transmitted the response message to limit traffic on the wireless communication system 400.

One or more approaches may be alternatively or simultaneously used to determine which devices function in the proxy capacity and are designated to respond to some or all request messages. For example, in some aspects, a no power drain constraint approach, volunteering approach, or shared burden approach may be used to determine which one or more devices respond to some or all request messages on behalf of other devices in the wireless communication system 400. In some aspects, devices may be deemed designated when the devices determine whether one or more other designated devices have transmitted a response message on behalf of another device.

Using the no power drain constraint approach, one or more devices, such as the third STA 406c, may be designated as no power drain constraint devices. The no power drain constraint devices may be devices that have access to mains power (e.g., wall outlet power) or a high capacity battery. As a result, the no power drain constraint devices may be less concerned with their power consumption and may advantageously respond to some or all request messages on behalf of other devices.

Using the volunteer approach, one or more devices, such as the third STA 406c, may be designated as volunteering devices. Volunteering devices may be those devices, for instance, that opt-in by transmitting an announcement message to become a device designated to respond to some or all request messages on behalf of other devices.

Using the shared burden approach, one or more devices, such as the third STA 406c, may be designated as temporarily designated devices to respond to some or all request messages. Temporarily designated devices may be those devices that share the burden of being one of the particular devices designated to respond to some or all request messages for certain periods of time and/or at certain times on behalf of other devices. Temporarily designated devices may be determined, for instance, by a round-robin approach based on increasing MAC addresses, round-robin approach within a group of certain types of devices (e.g., fixed devices share the burden for most of the time while mobile device share the burden for the remainder), or passing of a token based on a look-up table, and the like. In some aspects, one or more devices in the wireless communication system 400 may further be responsible for notifying devices of the temporary designation as temporarily designated devices.

Further, the selected one or more designation approaches for the wireless communication system 400 may depend on the conditions of the devices in a wireless communication system 400. For example, no power drain constraint devices may be designated respond to some or all request messages when the wireless communication system 400 includes no power drain constraint devices. In another example, a wireless communication system 400 that includes only devices having power drain constraints may designate one or more particular devices based on a volunteer approach, and if no devices volunteer, a temporarily designated devices approach may utilized.

As an example, the first STA 406a may be a service provider device, the second STA 406b may be a service consumer device, and the third STA 406c may be designed to respond to request messages in the wireless communication system 400. Before the second STA 406b enters the wireless communication system, the first STA 406a may transmit a configuration message, indicating the services provided by the first STA 406a. The third STA 406c may receive 410b the configuration message and store data indicative of the services provided by the first STA 406a, as well as the IP address or MAC address of the first STA 406a. The second STA 406b may then later enter the wireless communication system 400. While the first STA 406a may be in a power-save mode or sleep mode, the second STA 406b may transmit 410b a request message requesting a service provided by the first STA 406a. After determining that other devices have not yet responded to the request message and that the first STA 406a provides the requested service, the third STA 406c may respond to the request message with a response message indicating the second STA 406b to be the sender of the request message, as well as indicating that the first STA 406a provides the service requested by the second STA 406b. In some aspects, the third STA 406c may compare a ranking of the first device 406a to a threshold to determine whether to indicate that the first STA 406a provides the requested service. In addition, other designed devices (not shown) may sense that the third STA 406c transmitted a response message to the second STA 406b and determine not to transmit the response message.

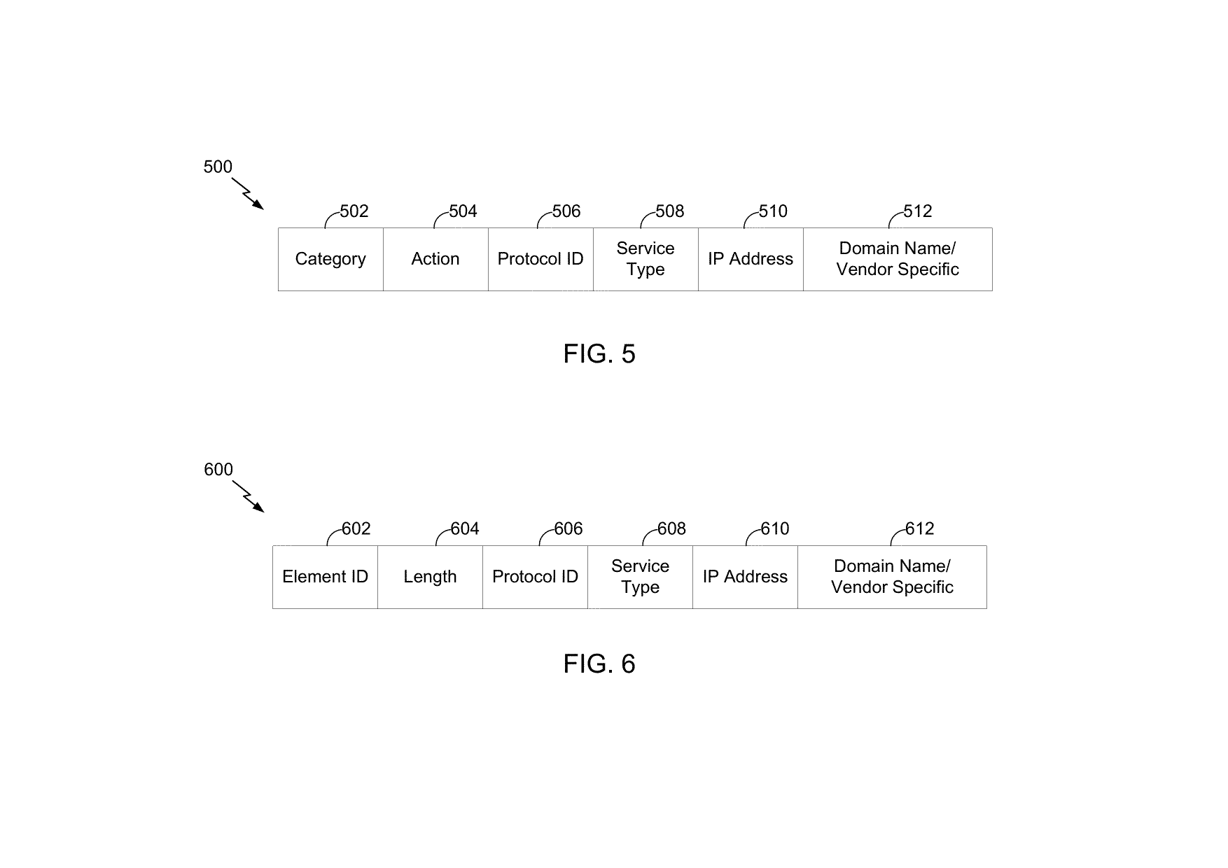

FIG. 5 illustrates an example action frame 500. The action frame 500 may serve as a component of a configuration message or discovery message, such as the configuration message discussed with respect to FIGS. 3 and 4. The action frame 500 may be a management frame. The management frame may be used rather than a data frame so that information contained in the action frame 500 can be processed or functions may be triggered on the MAC layer. The information contained in the action frame 500 may include information from or for upper layer protocols. Advantageously, the action frame 500 may enable a reduction of overhead in transmitting information from or for upper layer protocols over transmitting the information in upper layer discovery messages. For instance, overhead may be reduced over simply carrying the information as payloads of upper layer discovery messages. Additionally, the action frame 500 may serve other functions or combine separate steps performed in one or more messages of traditional protocols, such as Bonjour, Universal Plug and Play (UPnP), etc.

The action frame 500 may include a category field 502, an action field 504, a protocol identifier (ID) field 506, a service type field 508, an IP address field 510, and a domain name or vendor specific field 512. In one aspect, most fields of the action frame 500 may be 1 octet in length, and the IP address field 510 may be 4 or 16 octets in length and the domain name or vendor specific field 512 may be a variable number of octets in length. The action frame 500 may, for instance, advantageously be used to reduce the overhead of transmitting upper layer messages versus simply carrying discovery messages as a payload.

In some aspects, the protocol ID field 506 may indicate a upper layer protocol used for discovery (e.g., Bonjour, UPnP, DLNA, etc., or vendor specific) and whether the IP address field 510 includes an Internet Protocol version 4 (IPv4) or an Internet Protocol version 6 (IPv6) address, for instance. The service type field 508 may indicate the type of service provided by the advertising device transmitting the action frame (e.g., media server, chat service, deprecated for case of vendor specific, etc.). The IP address field 510 may include the generated IPv4 or IPv6 address of the transmitting device if, for example, the IP address configuration may have been completed before transmission of the action frame 500. The domain name and vendor specific field 512 may provide a domain name of the service (e.g., the uniform resource locator (URL) or universally unique identifier (UUID) for UPnP; the domain name for Bonjour) or some other use or format of the field specified by a vendor.

FIG. 6 illustrates an example information element 600. The information element 600 may serve as a component of a configuration message or discovery message, such as the configuration message discussed with respect to FIGS. 3 and 4. The information element 600 may be part of a management frame. The management frame may be used so that information contained in the information element 600 can be processed or functions may be triggered on the MAC layer. The information contained in the information element 600 may include information from or for upper layer protocols. Advantageously, the information element 600 may enable a reduction of overhead in transmitting information from or for upper layer protocols over transmitting the information in upper layer discovery messages. For instance, overhead may be reduced over simply carrying the information as payloads of upper layer discovery messages. Additionally, the information element 600 may serve other functions or combine separate steps performed in one or more messages of traditional protocols, such as Bonjour, UPnP, etc.

The information element 600 may include an element ID field 602, a length field 604, a protocol ID field 606, a service type field 608, an IP address field 610, and a domain name or vendor specific field 612. In one aspect, most fields of the information element 600 may be 1 octet in length, and the IP address field 610 may be 4 or 16 octets in length and the domain name or vendor specific field 612 may be a variable number of octets in length. The information element 600 may, for instance, advantageously be used to reduce the overhead of transmitting upper layer messages versus simply carrying discovery messages as a payload. Further, the information element 600 may prevent specific functions from triggering at the media access control layer since data frames may not be interpreted by the media access control layer.

In some aspects, the protocol ID field 606 may indicate a upper layer protocol used for discovery (e.g., Bonjour, UPnP, DLNA, etc., or vendor specific) and whether the IP address field 610 includes an IPv4 or an IPv6 address, for instance. The service type field 608 may indicate the type of service provided by the advertising device transmitting the information element (e.g., media server, chat service, deprecated for case of vendor specific, etc.). The IP address field 610 may include the generated IPv4 or IPv6 address of the transmitting device if, for example, the IP address configuration may have been completed before transmission of the information element 600. The domain name and vendor specific field 612 may provide a domain name of the service (e.g., the URL) or UUID for UPnP; the domain name for Bonjour) or some other use or format of the field specified by a vendor.

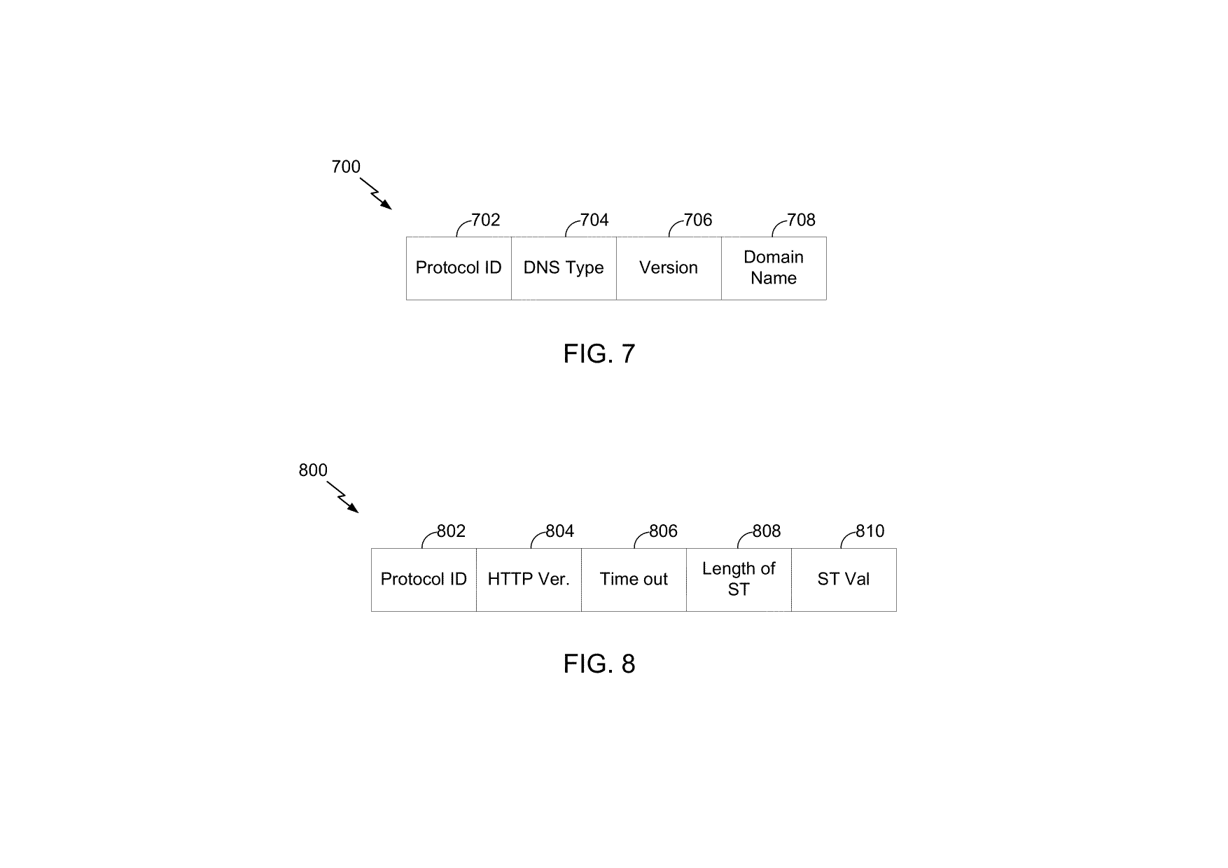

FIG. 7 illustrates an example Bonjour message format 700. The Bonjour message format 700 may exclude fields typically included in a Bonjour message, which may become redundant under the communication systems, devices, and methods described in this disclosure. The Bonjour message format 700 may include a protocol ID field 702, a DNS type field 704, a version field 706, and a domain name field 708. In one aspect, most fields may be 1 octet in length, and the version field 706 may be 2 octets in length and the domain name field 708 may be a variable number of octets in length.

FIG. 8 illustrates an example UPnP search message format 800. The UPnP search message format 800 may exclude fields typically included in an UPnP search message, which may become redundant under the communication systems, devices, and methods described in this disclosure. The UPnP search message format 800 may include a protocol ID field 802, a hypertext transfer protocol (HTTP) version field 804, a time out field 806, a length of search target (ST) field 808, and a search target value field 810. In one aspect, most fields may be 1 octet in length, and the time out field 806 may be 2 octets in length and ST value field 810 may be a variable number of octets in length. The UPnP search message format 800 may advantageously result in an approximately 30% to 50% decrease in the message size from a typical UPnP search message.

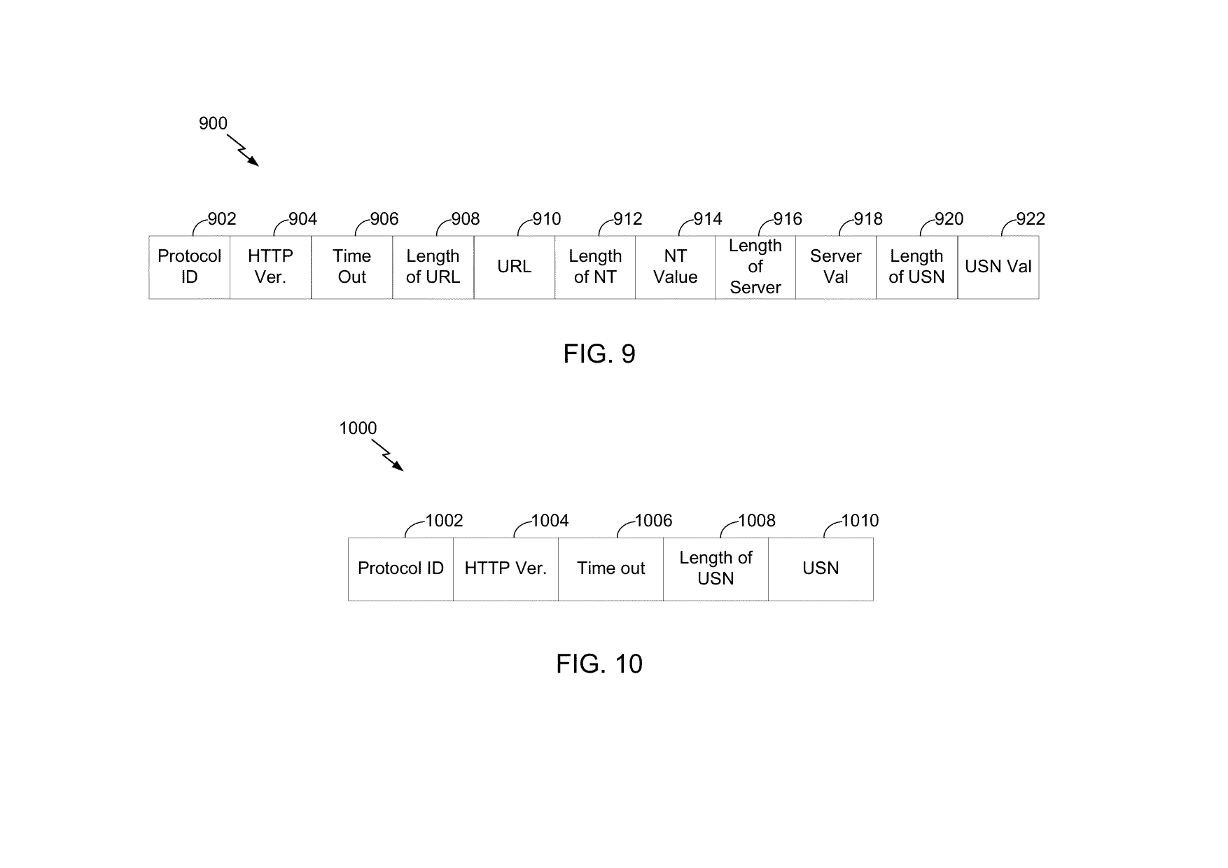

FIG. 9 illustrates an example UPnP notify message format 900. The UPnP notify message format 900 may exclude fields such as a host field or NTS field typically included in an UPnP notify message, which may become redundant under the communication systems, devices, and methods described in this disclosure. The UPnP notify message format 900 may include a protocol ID field 902, HTTP version field 904, a time out field 906, a length of URL field 908, a URL field 910, a length of NT field 912, a NT value field 914, a length of server field 916, a server value field 918, a length of USN field 920, and a USN value field 922. In one aspect, most fields may be 1 octet in length, and the time out field 906 may be 2 octets in length and the URL field 910, the NT value field 914, the server value field 918, and the USN value field 922 may be a variable number of octets in length. Further, in some implementations, simple service discovery protocol (SSDP) message containers may be compressed by indicating in the protocol ID field 902 that a message is a SSDP notify message and excluding data of one or more fields with redundant values. Accordingly, receiving devices may further be configured to decompress compressed messages. The UPnP notify message format 900 may advantageously result in an approximately 33% decrease in the message size from a typical UPnP notify message of 386 octets, for example.

FIG. 10 illustrates an example UPnP notify message format 1000. The UPnP notify message format 1000 may exclude fields typically included in an UPnP notify message, which may become redundant under the communication systems, devices, and methods described in this disclosure. The UPnP notify message format 1000 may include a protocol ID field 1002, HTTP version field 1004, a time out field 1006, a length of USN field 1008, and a USN field 1010. In one aspect, most fields may be 1 octet in length, and the time out field 1006 may be 2 octets in length and the USN field 1010 may be a variable number of octets.

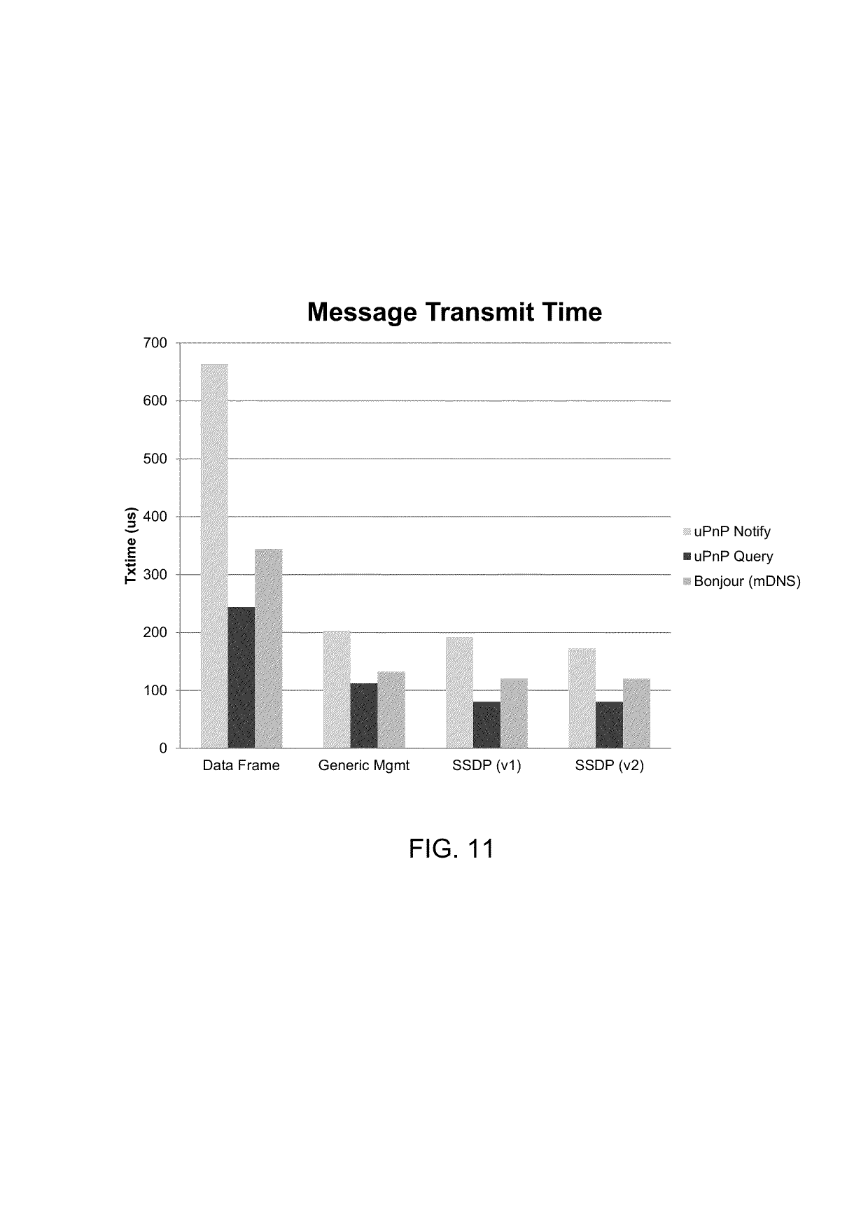

FIG. 11 is a graph illustrating message transmission times for various approaches to carrying discovery information. The graph demonstrates that over an approximately 50% transmission time savings may be realized by using the approaches described in this disclosure over simply carrying a discovery protocol message payload in traditional data frames.

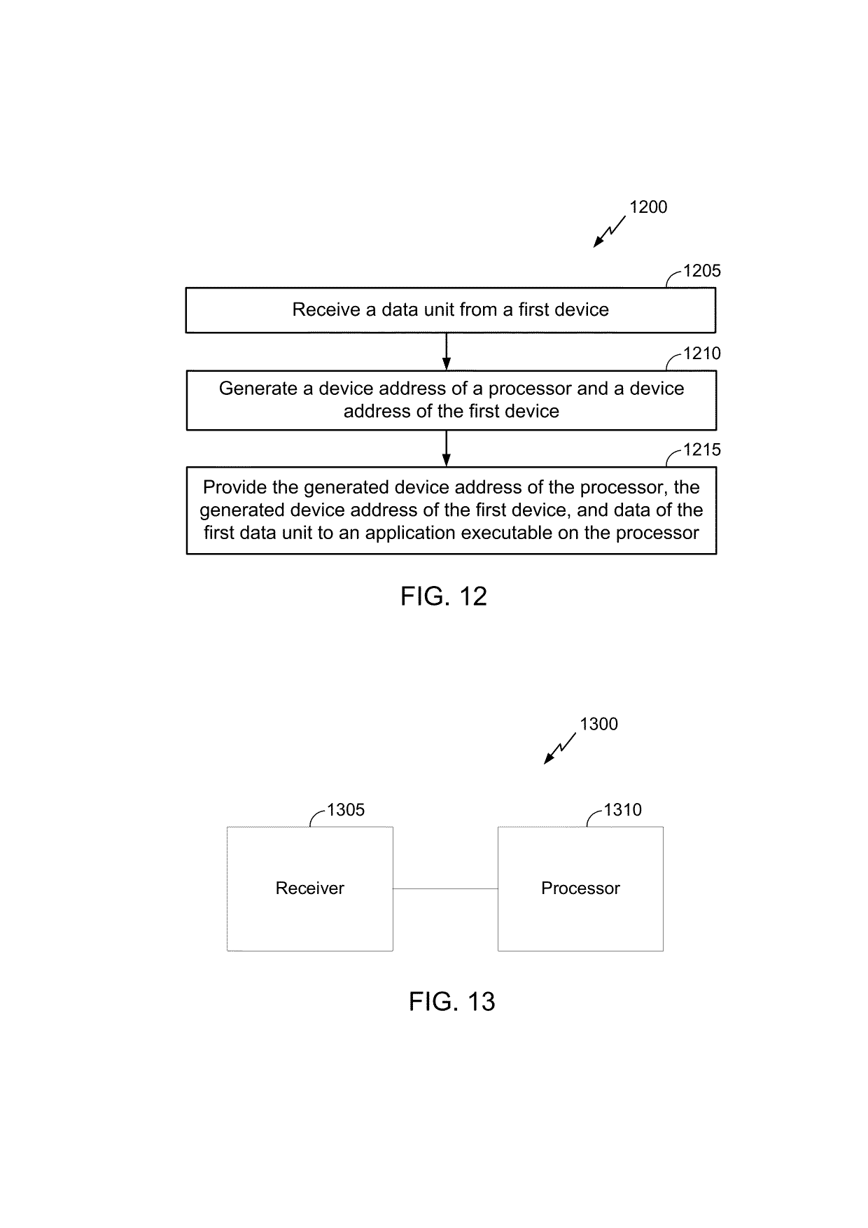

FIG. 12 is a flowchart of an example process 1200 of communicating in a wireless communication system in accordance with aspects of the present disclosure. The process 1200 may be used as discussed with respect to FIG. 3. Although the process 1200 is described below with respect to the elements of the wireless device 202, other components may be used to implement one or more of the steps described herein.

At block 1205, a data unit is received from a first device. The data unit may include a MAC address of the first device and data. The receiving process may be performed by the receiver 212, for example.

At block 1210, a device address of a processor and a device address of a first device is generated. The processor may be a component of a device separate from the first device. The generating may be performed by processor 204, for example.

At block 1215, the generated device address of the processor, the generated device address of the first device, and data of the data unit are provided to an application executable on the processor. The providing process may be completed using processor unit 204, for example.

FIG. 13 is a functional block diagram of an example wireless device 1300. The wireless device 1300 includes a receiver 1305 configured to perform one or more functions discussed above with respect to blocks 1205 of FIG. 12. The receiver 1305 may correspond to the receiver 212. The wireless device 1300 further includes a processor 1310 configured to perform one or more functions discussed above with respect to block 1210 of FIG. 12. The processor 1310 may correspond to processor 204.

Moreover, in one aspect, means for receiving a data unit comprises the receiver 1305. In another aspect, means for generating a device address and means for providing the generated addresses and data comprise the processor 1310.

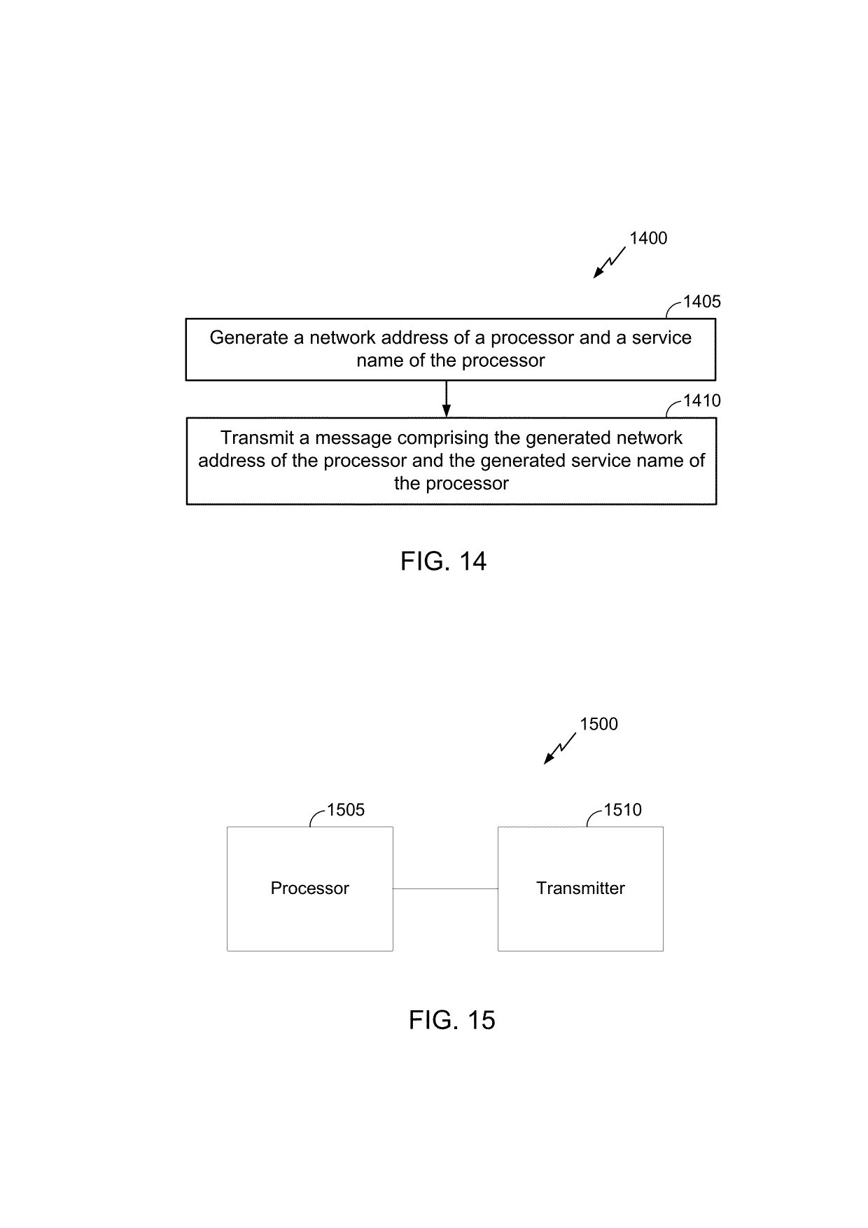

FIG. 14 is a flowchart of an example process 1400 of communicating in a wireless communication system in accordance with aspects of the present disclosure. The process 1400 may be used as discussed with respect to FIG. 3. Although the process 1400 is described below with respect to the elements of the wireless device 202, other components may be used to implement one or more of the steps described herein.

At block 1405, a network address of a processor and a service name of the processor are generated. The generating may be performed by processor 204, for example.

At block 1410, a message is transmitted that includes the generated network address of the processor and the generated service name of the processor. The transmitting process may be performed by transmitter 210, for example.

FIG. 15 is a functional block diagram of an example wireless device 1500. The wireless device 1500 includes a processor 1505 configured to perform one or more functions discussed above with respect to blocks 1405 of FIG. 14. The processor 1505 may correspond to processor 204. The wireless device 1500 further includes a transmitter 1510 configured to perform one or more functions discussed above with respect to blocks 1410 of FIG. 14. The transmitter 1510 may correspond to transmitter 210.

Moreover, in one aspect, means for generating a network address comprises the processor 1505. In another aspect, means for transmitting a message comprises the transmitter 1510.

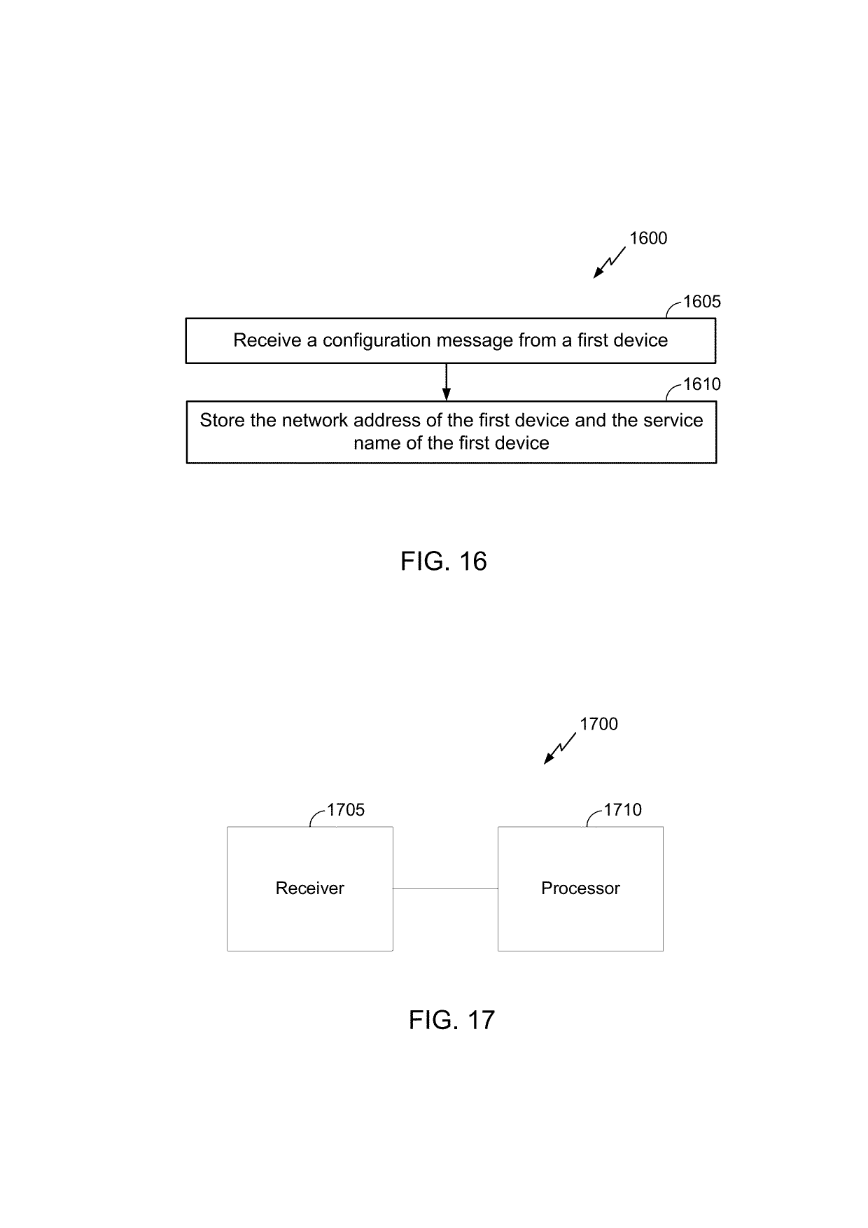

FIG. 16 is a flowchart of an example process 1600 of communicating in a wireless communication system in accordance with aspects of the present disclosure. The process 1600 may be used as discussed with respect to FIG. 3. Although the process 1600 is described below with respect to the elements of the wireless device 202, other components may be used to implement one or more of the steps described herein.

At block 1605, a configuration message is received from a first device. The configuration message may include a network address of the first device and a service name of the first device. The network address of the first device and the service name of the first device may be generated by the first device. The receiving may be performed by receiver 212, for example.

At block 1610, the network address of the first device and the service name of the first device are stored. The storing process may be performed by processor 204 in memory 206, for example.

FIG. 17 is a functional block diagram of an example wireless device 1700. The wireless device 1700 includes a receiver 1705 configured to perform one or more functions discussed above with respect to blocks 1605 of FIG. 16. The receiver 1705 may correspond to receiver 212. The wireless device 1700 further includes a processor 1710 configured to perform one or more functions discussed above with respect to blocks 1610 of FIG. 16. The processor 1710 may correspond to processor 204.

Moreover, in one aspect, means for receiving a configuration message may comprise the receiver 1705. In another aspect, means for storing may comprise the processor 1710.

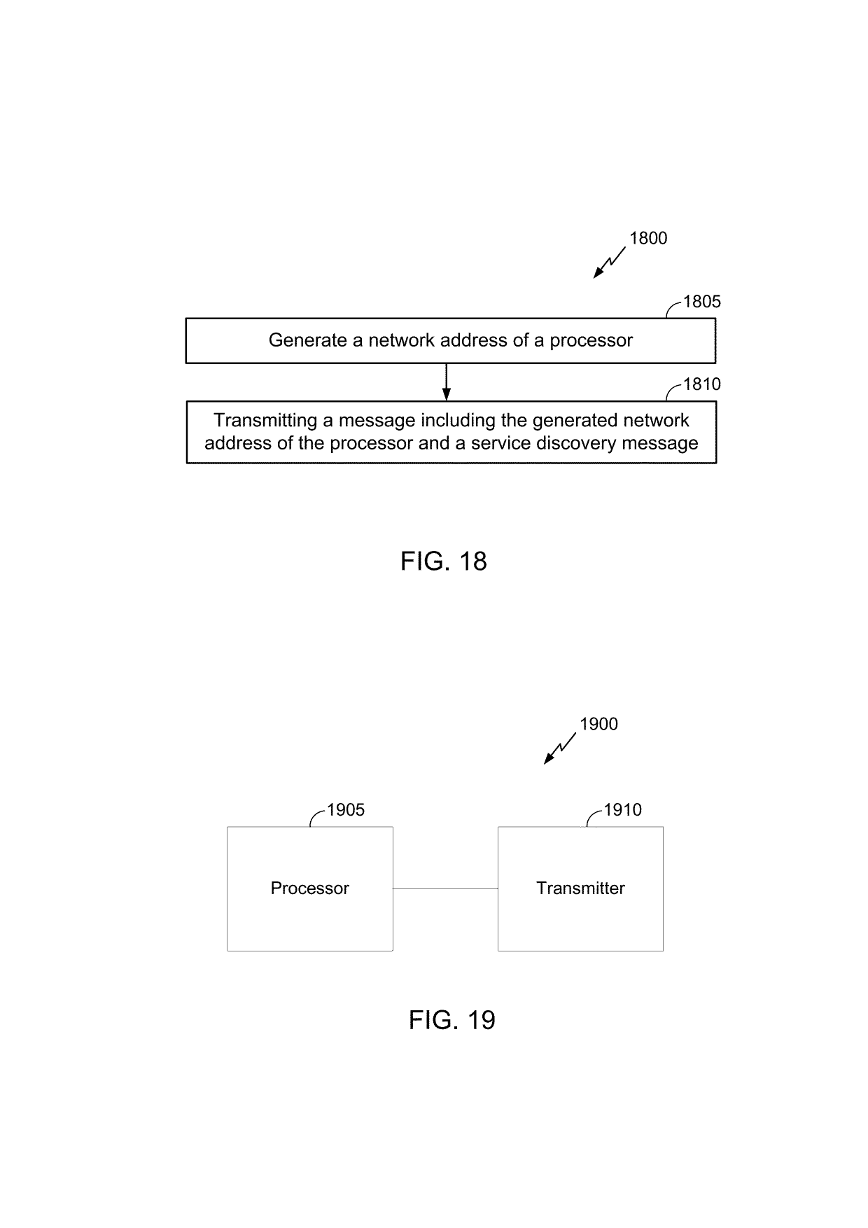

FIG. 18 is a flowchart of an example process 1800 of communicating in a wireless communication system in accordance with aspects of the present disclosure. The process 1800 may be used as discussed with respect to FIG. 3. Although the process 1800 is described below with respect to the elements of the wireless device 202, other components may be used to implement one or more of the steps described herein.

At block 1805, a network address of a processor is generated. The generating may be performed by processor 204, for example.

At block 1810, a message may be transmitted that includes the generated network address of the processor and a service discovery message. The transmitting process may be performed by transmitter 210, for example.

FIG. 19 is a functional block diagram of an example wireless device 1900. The wireless device 1900 includes a processor 1905 configured to perform one or more functions discussed above with respect to blocks 1805 of FIG. 18. The processor 1905 may correspond to processor 204. The wireless device 1900 further includes a transmitter 1910 configured to perform one or more functions discussed above with respect to blocks 1810 of FIG. 18. The transmitter 1910 may correspond to transmitter 210.

Moreover, in one aspect, means for generating a network address may comprise the processor 1905. In another aspect, means for transmitting a message may comprise the transmitter 1910.

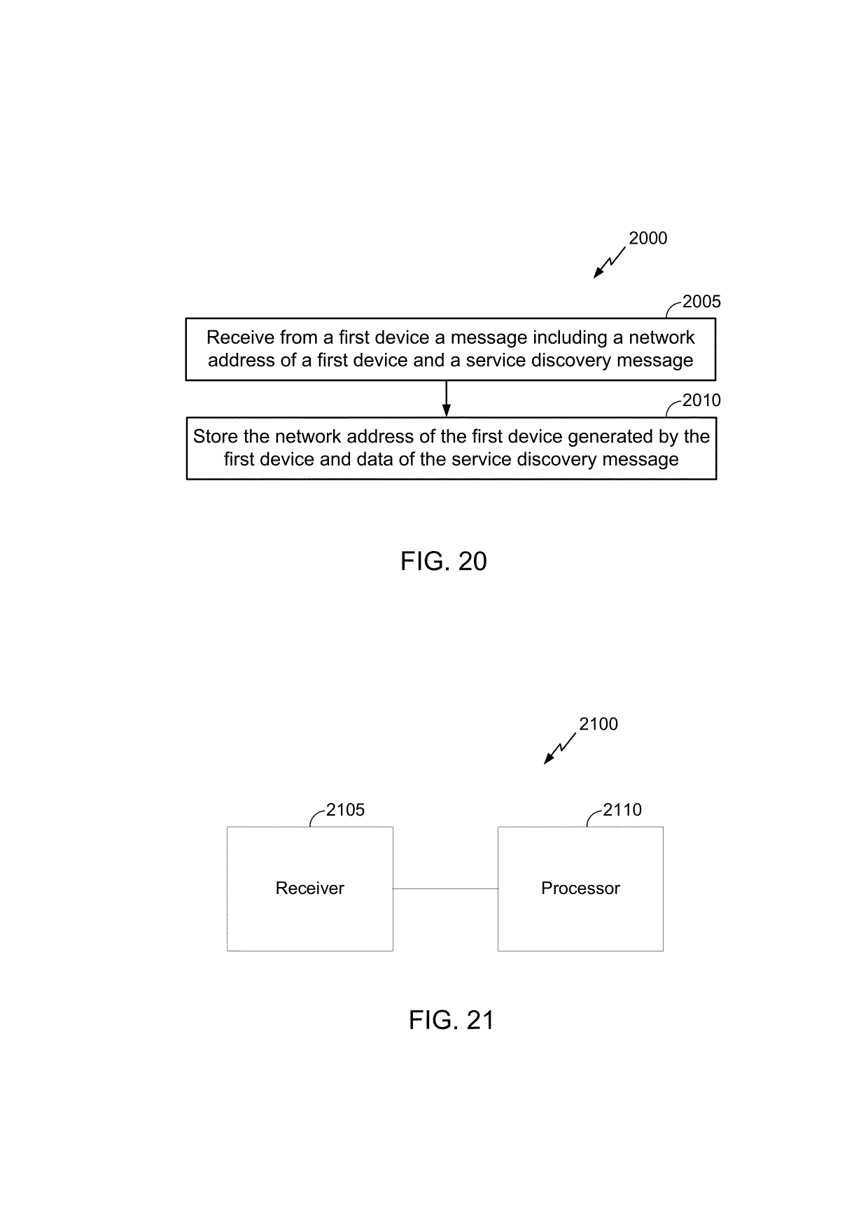

FIG. 20 is a flowchart of an example process 2000 of communicating in a wireless communication system in accordance with aspects of the present disclosure. The process 2000 may be used as discussed with respect to FIG. 3. Although the process 2000 is described below with respect to the elements of the wireless device 202, other components may be used to implement one or more of the steps described herein.

At block 2005, a message is received from a first device. The message may include a network address of the first device and a service discovery message. The network address of the first device may be generated by the first device. The receiving may be performed by receiver 212, for example.

At block 2010, the network address of the first device generated by the first device and data of the service discovery message is stored. The storing process may be performed by processor 204 in memory 206, for example.

FIG. 21 is a functional block diagram of an example wireless device 2100. The wireless device 2100 includes a receiver 2105 configured to perform one or more functions discussed above with respect to blocks 2005 of FIG. 20. The receiver 2105 may correspond to receiver 212. The wireless device 2100 further includes a processor 2110 configured to perform one or more functions discussed above with respect to blocks 2010 of FIG. 20. The processor 2110 may correspond to processor 204.

Moreover, in one aspect, means for receiving a message may comprise the receiver 2105. In another aspect, means for storing the network address may comprise the processor 2110.

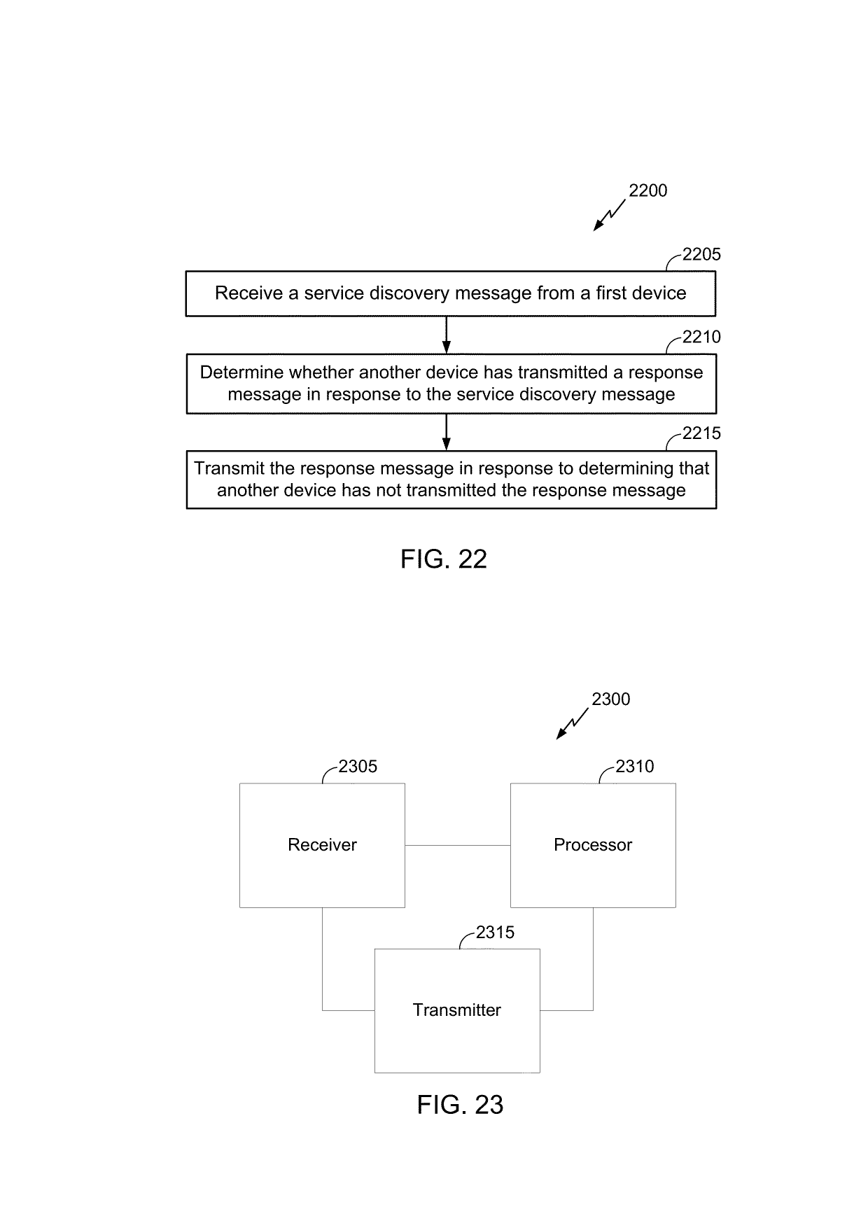

FIG. 22 is a flowchart of an example process 2200 of communicating in a wireless communication system in accordance with aspects of the present disclosure. The process 2200 may be used as discussed with respect to FIG. 4. Although the process 2200 is described below with respect to the elements of the wireless device 202, other components may be used to implement one or more of the steps described herein.

At block 2205, a service discovery message is received from a first device. The service discovery message may request a service in the wireless communication network for the first device. The receiving may be performed by receiver 212, for example.

At block 2210, it is determined whether another device has transmitted a response message in response to the service discovery message. The response message may indicate a request by the first device for the service and at least one device that provides the service. The determining process may be performed by processor 204, for example.

At block 2215, the response message is transmitted in response to determining that another device has not transmitted the response message. The transmitting process may be performed by transmitter 210, for example.

FIG. 23 is a functional block diagram of an example wireless device 2300. The wireless device 2300 includes a receiver 2305 configured to perform one or more functions discussed above with respect to blocks 2205 of FIG. 22. The receiver 2305 may correspond to receiver 212. The wireless device 2300 further includes a processor 2310 configured to perform one or more functions discussed above with respect to blocks 2210 of FIG. 22. The processor 2310 may correspond to processor 204. The wireless device 2300 further includes a transmitter 2315 configured to perform one or more functions discussed above with respect to blocks 2215 of FIG. 22. The transmitter 2315 may correspond to the transmitter 210.

Moreover, in one aspect, means for receiving a service discovery message may comprise the receiver 2305. In another aspect, means for determining whether another device has transmitted a response message may comprise the processor 2310. In yet another aspect, means for transmitting the response message may comprise the transmitter 2315.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus operable in a wireless communication network, the apparatus comprising:
a receiver configured to receive a first data unit from a first device, the first data unit comprising a Media Access Control (MAC) address of the first device and data; and
a processor configured to
generate a device address of the processor and a device address of the first device, and
provide the generated device address of the processor, the generated device address of the first device, and the data of the first data unit to an application executable on the processor.

2. The apparatus of claim 1, wherein the processor is configured to generate the device address of the first device based on the MAC address of the first device.

3. The apparatus of claim 2, wherein the processor is further configured to
tore the generated device address of the first device, the MAC address of the first device, a device name of the first device, and an association between the device name, the generated device address of the first device, and the MAC address of the first device, and
determine the MAC address of the first device based on the association between the generated device address of the first device and the MAC address of the first device.

4. The apparatus of claim 3, further comprising a transmitter configured to transmit a second data unit to the first device, the second data unit comprising a MAC address of the processor and the MAC address of the first device.

5. The apparatus of claim 4, wherein the second data unit further comprises the generated device address of the processor and the generated device address of the first device, wherein the generated device address of the processor comprises an Internet Protocol (IP) address of the processor and the generated device address of the first device comprises an IP address of the first device.

6. The apparatus of claim 1, wherein the first data unit further comprises a MAC address of the processor.

7. The apparatus of claim 1, wherein the processor is configured to generate the device address of the processor and the device address of the first device using a first algorithm, and the first device is configured to generate a device address of the processor and a device address of the first device using a second algorithm, the first algorithm being different from the second algorithm.

8. The apparatus of claim 7, wherein the first data unit further comprises the device address of the processor generated by the first device and the device address of the first device generated by the first device.

9. The apparatus of claim 7, wherein the processor is further configured to select the first algorithm of a plurality of algorithms.

10. A method of wireless communication in a wireless communication network performed by an apparatus including a processor, the method comprising:
receiving a first data unit from a first device, the first data unit comprising a Media Access Control (MAC) address of the first device and data;
generating a device address of the processor and a device address of the first device; and
providing the generated device address of the processor, the generated device address of the first device, and the data of the first data unit to an application executable on the processor.

11. The method of claim 10, wherein said generating the device address of the first device comprises generating the device address of the first device based on the MAC address of the first device.

12. The method of claim 11, further comprising:
storing the generated device address of the first device, the MAC address of the first device, a device name of the first device, and an association between the device name, the generated device address of the first device, and the MAC address of the first device; and
determining the MAC address of the first device based on the association between the generated device address of the first device and the MAC address of the first device.

13. The method of claim 12, further comprising transmitting a second data unit to the first device, the second data unit comprising a MAC address of the processor and the MAC address of the first device.

14. The method of claim 13, wherein the second data unit further comprises the generated device address of the processor and the generated device address of the first device, wherein the generated device address of the processor comprises an Internet Protocol (IP) address of the processor and the generated device address of the first device comprises an IP address of the first device.

15. The method of claim 10, wherein the first data unit further comprises a MAC address of the processor.

16. The method of claim 10, wherein said generating the device address of the processor and the device address of the first device comprises generating the device address of the processor and the device address of the first device using a first algorithm, and the first device is configured to generate a device address of the processor and a device address of the first device using a second algorithm, the first algorithm being different from the second algorithm.

17. The method of claim 16, wherein the first data unit further comprises the device address of the processor generated by the first device and the device address of the first device generated by the first device.

18. The method of claim 16, further comprising selecting the first algorithm of a plurality of algorithms.

19. An apparatus operable in a wireless communication network, the apparatus comprising:
means for receiving a first data unit from a first device, the first data unit comprising a Media Access Control (MAC) address of the first device and data;
means for generating a device address of the means for generating and a device address of the first device; and
means for providing the generated device address of the means for generating, the generated device address of the first device, and the data of the first data unit to an application executable on the means for generating.

20. A non-transitory computer storage that stores executable program instructions that direct an apparatus including a processor to perform a process that comprises:
receiving a first data unit from a first device, the first data unit comprising a Media Access Control (MAC) address of the first device and data;
generating a device address of the processor and a device address of the first device; and
providing the generated device address of the processor, the generated device address of the first device, and the data of the first data unit to an application executable on the processor.

21. A method of wireless communication in a wireless communication network performed by an apparatus including a processor, the method comprising:
generating a network address of the processor and a service name of the processor; and
transmitting an advertisement message comprising the generated network address of the processor and the generated service name of the processor.

22. The method of claim 21, further comprising transmitting the advertisement message one or more times, the advertisement message being a single message.

23. The method of claim 21, wherein said generating the network address of the processor comprises generating the network address of the processor based on a Media Access Control address of the processor.

24. A method of wireless communication in a wireless communication network performed by an apparatus including a processor, the method comprising:
receiving a service discovery message from a first device, the service discovery message requesting a service in the wireless communication network;
determining whether a second device has transmitted a response message in response to the service discovery message, the response message indicating a request by the first device for the service and at least one device that provides the service; and
transmitting the response message in response to determining that the second device has not transmitted the response message.

25. The method of claim 24, further comprising receiving a configuration message from a third device, the configuration message indicating a service name of the third device or a service provided by the third device in the wireless communication network.

26. The method of claim 25, further comprising:
determining whether the third device provides the service requested in the service discovery message; and
in response to determining that the third device provides the service requested in the service discovery message, indicating in the response message that the third device provides the service.

27. The method of claim 25, further comprising:
determining whether the third device provides the service requested in the service discovery message;
in response to determining that the third device provides the service requested in the service discovery message, comparing a ranking of the third device to a threshold; and
based on the comparison of the ranking of the third device to the threshold, determining whether to indicate in the response message transmitted by the transmitter that the third device provides the service.
